(19) United States
(12) Patent Application Publication
(10) Pub. No.: US 2025/0256416 A1
(43) Pub. Date: Aug. 14, 2025

(54) RAZOR HANDLE

(71) Applicant: DORCO CO., LTD., Yongin-si (KR)

(72) Inventors: Young Jin LEE, Seoul (KR); Seung Min SONG, Seoul (KR); Shin Hwan PARK, Seoul (KR)

(21) Appl. No.: 19/193,706

(22) Filed: Apr. 29, 2025

Related U.S. Application Data
(63) Continuation of application No. PCT/KR2023/017474, filed on Nov. 3, 2023.

(30) Foreign Application Priority Data
Nov. 4, 2022 (KR) 10-2022-0146068

(51) Int. Cl. B26B 21/52

(52) U.S. Cl. CPC B26B 21/521; B26B 21/522

(57) ABSTRACT

A razor handle is proposed. The razor handle may include an elongated-type grip portion having a hollow portion, and a body portion comprising a latch portion. At least part of the body portion may be configured to be accommodated in the hollow portion. The razor handle may also include a head portion configured to be connected to a razor cartridge, the head portion connected to one side of the body portion. The razor handle may also include a fixing pin configured to be coupled to the other side of the body portion. When the fixing pin is positioned on the other side of the body portion, the fixing pin may be configured to be latch-coupled with the latch portion by rotating in a first direction around a rotational axis passing through the body portion and parallel to a longitudinal direction of the body portion.

### CROSS-REFERENCE TO RELATED APPLICATIONS

This is a continuation application of International Patent Application No. PCT/KR2023/017474 filed on Nov. 3, 2023, which claims priority to Korean Patent Application No. 10-2022-0146068 filed on Nov. 4, 2022, the contents of each of which are incorporated by reference herein in their entirety.

### BACKGROUND

### Technical Field

The present disclosure relates to a razor handle.

### Description of Related Technology

The seriousness of environmental destruction has recently emerged, and accordingly, each country and various international organizations are establishing measures related to environmental regulations. For example, measures such as prohibiting or reducing the use of disposable plastics are being established, and accordingly, the manufacturers of various disposable products are replacing at least part of their products with eco-friendly materials.

### SUMMARY

One aspect is a razor handle that not only utilizes an eco-friendly material but also allows for easy separation and replacement of the eco-friendly material.

Another aspect is a razor handle comprising: an elongated-type grip portion having a hollow portion; a body portion comprising a latch portion, wherein at least of the body portion configured to be accommodated in the hollow portion; a head portion configured to be connected to a razor cartridge, the head portion connected to one side of the body portion; and a fixing pin configured to be coupled to the other side of the body portion, wherein when the fixing pin is positioned on the other side of the body portion, the fixing pin is configured to be latch-coupled with the latch portion by rotating in a first direction around a rotational axis passing through the body portion and parallel to a longitudinal direction of the body portion.

According to an embodiment of the present disclosure described above, there is the effect that it is possible to provide a razor handle that not only utilizes an eco-friendly material but also allows for easy separation and replacement of the eco-friendly material.

### BRIEF DESCRIPTION OF THE DRAWINGS

FIG. 1 is a top view of a razor assembly in an assembled state according to an embodiment of the present disclosure.

FIG. 2 is an exploded perspective view of the razor assembly according to an embodiment of the present disclosure.

FIG. 3 is a cross-sectional view of the razor handle, taken along line A-A′ in FIG. 1 and shown in a Y-axis direction, according to an embodiment of the present disclosure.

FIG. 4A to FIG. 4C are views showing a process in which a fixing pin according to an embodiment of the present disclosure is moved along at least one guide groove.

FIG. 5A to FIG. 5D are enlarged views showing a process in which the fixing pin according to an embodiment of the present disclosure is latch-coupled to a latch portion.

FIG. 6A to FIG. 6C are cross-sectional views shown in the Y-axis direction after cutting the fixing pin and a body portion shown in FIG. 5B to FIG. 5D along line B-B′, including a grip portion.

### DETAILED DESCRIPTION

Domestically, the government aims to reduce the amount of waste generated relative to Gross Domestic Product (GDP) by 20% by 2027 and increase the current effective recycling rate from 70% to 82%. Further, to this end, plans are in place to provide financial support and prototype assistance to promote development and production of eco-friendly materials as alternatives to plastic.

Meanwhile, a wet razor falls into the category of products that require periodic replacement due to repeated use or single-use disposal. Therefore, in the market related to wet razors, there is a need for razors that comply with such environmental regulations, but most razors currently in use are made primarily of plastic materials.

Further, products in which certain components of the razor assembly, such as a razor handle, are manufactured using eco-friendly materials have been introduced. However, since components made of eco-friendly materials cannot be separated when disposing of the razor assembly, there is a problem of increased unnecessary waste.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

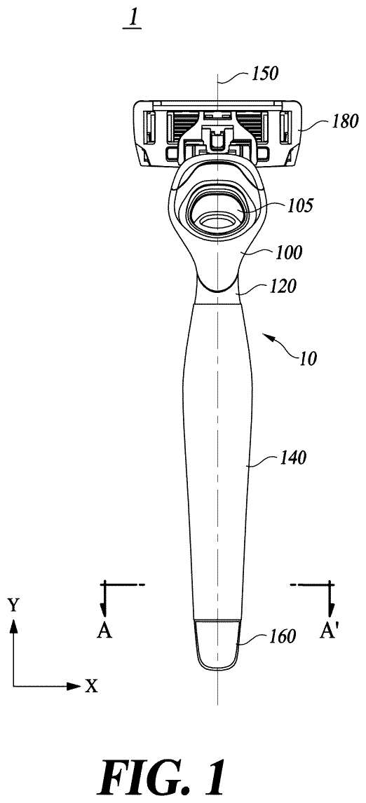

FIG. 1 is a top view of a razor assembly 1 in an assembled state according to an embodiment of the present disclosure.

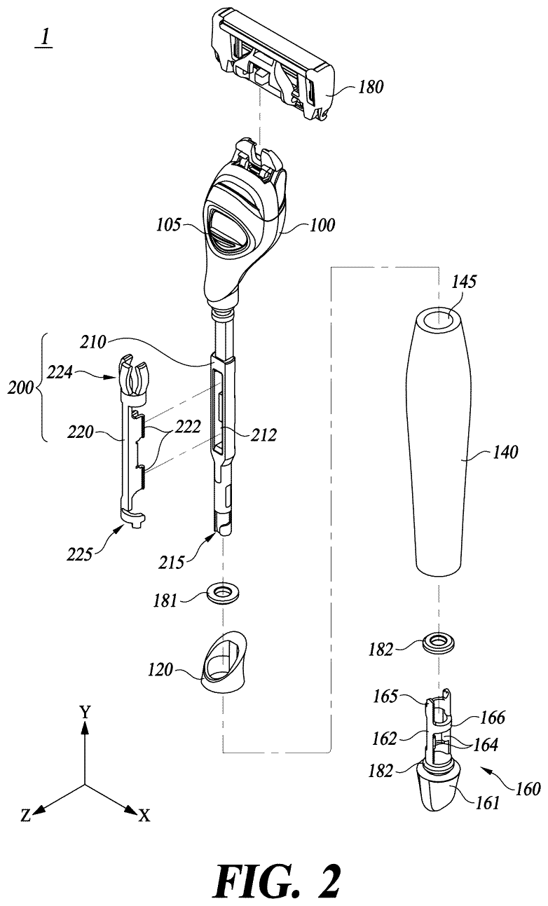

FIG. 2 is an exploded perspective view of the razor assembly 1 according to an embodiment of the present disclosure.

Referring to FIG. 1 and FIG. 2, a razor assembly 1 according to an embodiment of the present disclosure may comprise a razor cartridge 180 and a razor handle 10.

The razor handle 10 may comprise all or some of a grip portion 140, a body portion 200, a head portion 100, a buffer unit 120, and a fixing pin 160.

The grip portion 140 has a hollow portion 145 and is configured in an elongated type. The grip portion 140 can provide a region enabling a user to hold the razor handle 10 when shaving.

Further, the grip portion 140 may include at least one of materials that are recyclable, reusable, and/or degradable (e.g., biodegradation, photodegradation, and composite degradation). For example, the grip portion 140 may be manufactured using eco-friendly materials such as wood, metal, glass, and biomass. Accordingly, the razor handle 10 according to an embodiment of the present disclosure can minimize the proportion of plastic constituting a razor.

Meanwhile, even when using eco-friendly materials, if separation and replacement of such eco-friendly materials are not easy, recycling and reuse may become difficult. Accordingly, hereafter, a structure for easy separation and replacement of the grip portion 140 is described.

The body portion 200 is configured such that at least a portion thereof can be accommodated in the hollow portion 145. For example, the body portion 200 may be configured such that at least a portion extends in a direction parallel to the Y-axis direction in FIG. 2, and accordingly, the body portion 200 may be configured to pass through at least a portion of the hollow portion 145.

The body portion 200 may comprise a latch portion 225 and at least one guide groove 215. The latch portion 225 may be latch-coupled with the fixing pin 160 to be described below, and the guide groove 215 can guide the latch coupling. Detailed description related to the latch portion 225 and the guide groove 215 will be provided below.

The body portion 200 may comprise a tension unit 224 for elastically supporting at least a portion of the inner circumferential surface of the hollow portion 145 when at least a portion thereof is accommodated in the hollow portion 145. The tension unit 224 may include an elastic material and be compressed in a direction not parallel to the longitudinal direction of the body portion 200 when the body portion 200 is accommodated in the hollow portion 145, thereby being able to provide a supporting force toward at least a portion of the inner circumferential surface of the hollow portion 145.

The tension unit 224 may protrude convexly in a direction not parallel to the longitudinal direction of the body portion 200. In this case, when the body portion 200 is accommodated in the hollow portion 145, the convexly protruding portion can be compressed toward the longitudinal central axis of the body portion 200, whereby the tension unit 224 can provide a supporting force toward at least a portion of the inner circumferential surface of the hollow portion 145. However, as long as the tension unit 224 can elastically support at least a portion of the inner circumferential surface of the hollow portion 145, the shape of the tension unit 224 is not necessarily limited thereto.

Further, the tension unit 224 is composed of a plurality of arms formed symmetrically with respect to the longitudinal direction of the body portion 200 and spaced apart from each other in FIG. 2, but it is also not necessarily limited to this shape.

Meanwhile, the body portion 200 may comprise a first body portion 210 and a second body portion 220. Further, the first body portion 210 may include a rigid material and the second body portion 220 may include an elastic material.

The second body portion 220 may be coupled to at least one side of the first body portion 210, and the latch portion 225 and the tension unit 224 may be integrally formed on the second body portion 220. Further, the at least one guide groove 215 may be integrally formed on the first body portion 210. In this case, with respect to the body portion 200, the tension unit 224 may be positioned at the positive Y-axis side, and the latch portion 225 and the at least one guide groove 215 may be positioned at the negative Y-axis side.

Further, the first body portion 210 may comprise at least one coupling hole 212 for coupling to the second body portion 220, and the second body portion 220 may comprise at least one coupling protrusion 222 coupled to the at least one coupling hole 212. In this case, the first body portion 210 and the second body portion 220 can be coupled and separated in a direction parallel to the Z-axis direction in FIG. 2, but are not necessarily limited thereto.

The head portion 100 is configured to be connected to one side of the body portion 200 and connected to the razor cartridge 180. For example, the head portion 100 may be connected to the positive Y-axis side of the body portion 200 in FIG. 2.

In this case, the razor cartridge 180 may be connected to be able to pivot with respect to the razor handle 10, but is not necessarily limited thereto.

For example, the razor cartridge 180 may be mounted on the razor handle 10 such that it can be replaced, and the razor cartridge 180 may be mounted on the razor handle 10 using a fixed-type connector or a rotary-type connector. Further, one side of the razor cartridge 180 may be directly mounted on the one side of the razor handle 10.

Meanwhile, the head portion 100 may comprise a cartridge ejection button 105 protruding to the outside so that a user can operate it. In this case, a user can attach/detach the razor cartridge 180 to/from the razor handle 10 by operating the cartridge ejection button 105, for example, pressing, pushing, or pulling the cartridge ejection button 105.

The buffer unit 120 is disposed between an end of the grip portion 140 adjacent to the head portion 100 and the head portion 100. The buffer unit 120 prevents direct contact of the head portion 100 and the grip portion 140 in shaving, whereby it can prevent damage to the end of the grip portion 140 adjacent to the head portion 100 due to repeated contact, and accordingly, it can extend the lifespan of the grip portion 140. Further, the buffer unit 120 can also prevent pressure, which is applied to the head portion 100 during shaving or when the razor handle 10 is impacted by a fall, from being directly transmitted to the grip portion 140.

Meanwhile, it is possible to freely adjust the gap between the head portion 100 and the grip portion 140, depending on the size and shape of the buffer unit 120. In order to improve the grip of the razor handle 10, a rubber pattern may be formed on the buffer unit 120, but the present disclosure is not necessarily limited thereto.

The fixing pin 160 is configured to be coupled to the other side of the body portion 200. For example, the fixing pin 160 may be coupled to the negative Y-axis side of the body portion 200 in FIG. 2.

In this case, the fixing pin 160 is positioned on the other side of the body portion 200, and in this state, is rotated in a first direction around a rotational axis 150 passing through the body portion 200 in the longitudinal direction of the body portion 200, whereby it can be coupled with the latch portion 225. In this case, the first direction, for example, may refer to the clockwise direction around the rotational axis 150 in FIG. 1, but is not necessarily limited thereto.

Further, the latch coupling of the fixing pin 160 with the latch portion 225 can be disengaged by rotating the fixing pin 160 in a second direction opposite to the first direction, for example, counterclockwise around the rotational axis 150.

Accordingly, the razor handle 10 according to an embodiment of the present disclosure is configured such that the body portion 200 and the fixing pin 160 are latch-coupled and decoupled using rotation of the fixing pin 160, so it has the advantage in that the grip portion 140, which may include an eco-friendly material, can be easily separated for disposal and replaced.

Meanwhile, when the fixing pin 160 is latch-coupled to the latch portion 225, at least a portion of the fixing pin 160, for example, a fixing pin head 161 may be supported by the end of the grip portion 140 adjacent to the fixing pin 160. Accordingly, even after the fixing pin 160 is latch-coupled to the latch portion 225, it can be firmly maintained in the state.

The fixing pin 160 may comprise at least one guide arm 162 and a guide protrusion 164.

The at least one guide arm 162 extends in a direction parallel to the longitudinal direction of the body portion 200. For example, in FIG. 2, the at least one guide arm 162 is provided as two guide arms. The two guide arms 162 may extend symmetrically with respect to the rotational axis 150, in this case, the two guide arms 162 may be spaced apart from each other by a predetermined distance. This will be described in detail below.

However, the shape and the formation position of the at least one guide arm 162 are not necessarily limited thereto.

Further, when the at least one guide arm 162 is provided as a plurality of guide arms, at least one bridge 166 may be configured to connect between the plurality of guide arms 162. For example, as shown in FIG. 2, when the plurality of guide arms 162 is provided as two guide arms, the at least one bridge 166 may be provided as two bridges. In FIG. 2, one bridge may be formed on the positive X-axis side and the other one may be formed on the negative X-axis side, and the two bridges 166 may be formed not to face each other. However, the shape and the formation position of the at least one bridge 166 are not necessarily limited thereto.

Since the at least one bridge 166 is configured to connect the plurality of guide arms 162, it may provide a supporting force between the plurality of guide arms 162 and can maintain the distance between the plurality of guide arms 162.

Meanwhile, though not shown in the figures, when the at least one guide arm 162 is provided as two guide arms, the at least one guide groove 215 may also be provided as two guide grooves, and it is preferable that the number of the at least one guide arm 162 and the number of the at least one guide groove 215 are the same in this way. However, the present disclosure is not necessarily limited thereto.

The at least one guide arm 162 is a component that is inserted first into the hollow portion 145 so that the fixing pin 160 is latch-coupled to the body portion 200, and can guide the insertion direction of the fixing pin 160 to a user.

For example, when the at least one guide arm 162 is provided as two guide arms, the two guide arms 162 should be inserted in the Z-axis direction to face each other when they are inserted into the hollow portion 145 so that the fixing pin 160 can be rotated and latch-coupled. In this case, when the first body portion 210 is accommodated in the hollow portion 145, the two guide grooves 215 can be accommodated to face each other in the Z-axis direction.

Further, the at least one guide arm 162 may comprise, at an end, a locking portion 165 latch-coupled to the latch portion 225 and configured to generate a cam action with the latch portion 225. Detailed description related to the cam action of the locking portion 165 will be described below.

The guide protrusion 164 protrudes from the at least one guide arm 162 and is configured to be movable along the at least one guide groove 215. For example, as shown in FIG. 2, when the at least one guide arm 162 is provided as two guide arms, the guide protrusion 164 may protrude from each of the guide arms 162 and the protrusion may be directed toward the rotational axis 150, but is not necessarily limited thereto.

Since the guide protrusion 164 is configured to move along the at least one guide groove 215, it can guide the coupling direction of the fixing pin 160 to a user. This will be described in detail below.

Meanwhile, the razor handle 10 according to an embodiment of the present disclosure may comprise at least one sealing member 181, 182. For example, the at least one sealing member 181, 182 may be provided as two sealing members, as in FIG. 2, and they may be positioned between the grip portion 140 and the head portion 100 and between the grip portion 140 and the fixing pin 160, respectively. In this case, with respect to the grip portion 140, the sealing member 181 between the grip portion 140 and the head portion 100 may be positioned on the positive Y-axis side and the sealing member 182 between the grip portion 140 and the fixing pin 160 may be positioned on the negative Y-axis side. Accordingly, the fixing forces between the grip portion 140 and the head portion 100 and between the grip portion 140 and the fixing pin 160 can be increased.

Further, the sealing members 181 and 182 prevent water from permeating the interior of the razor handle 10, thereby being able to prevent the grip portion 140, etc. that are made of decomposable materials from being contaminated and damaged.

However, the number and position of the at least one sealing member 181, 182 are not necessarily limited to those described above.

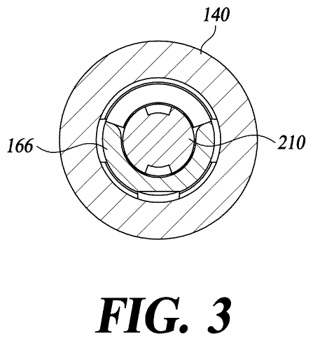

FIG. 3 is a cross-sectional view of the razor handle, taken along line A-A′ in FIG. 1 and shown in the Y-axis direction, according to an embodiment of the present disclosure.

Referring to FIG. 3, when the fixing pin 160 comprises two guide arms 162, the two guide arms 162 are configured not to be in contact with the inner wall of the grip portion 140 when they are accommodated in the hollow portion 145. The distance between the two guide arms 162 may be larger than the diameter of the first body portion 210, so the first body portion 210 can be easily inserted between the guide arms 162.

When the fixing pin 160 is accommodated in the hollow portion 145, the fixing pin can be freely rotated and moved unless the two guide protrusions 164 are engaged with the two guide grooves 215. Accordingly, a user can easily insert the fixing pin 160 into the hollow portion 145 or easily separate the fixing pin 160 from the hollow portion 145.

Further, the guide groove 215 is not exposed to the outside when the body portion 200 is accommodated in the hollow portion 145, so when a user initially inserts the fixing pin 160 into the hollow portion 145, the guide protrusion 164 may not be engaged with the guide groove 215. However, even in this case, a user can freely rotate or move the fixing pin 160 so that the guide protrusion 164 is engaged with the guide groove 215, so the fixing pin 160 can be more easily latch-coupled.

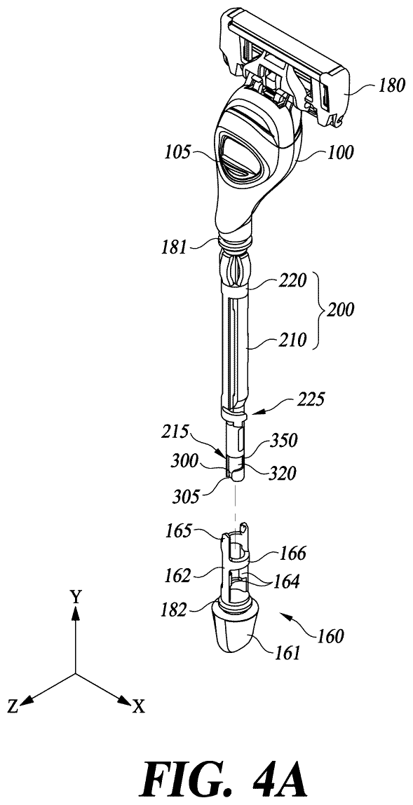

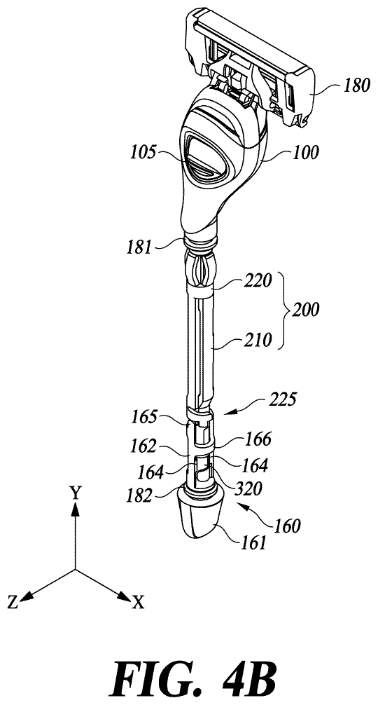

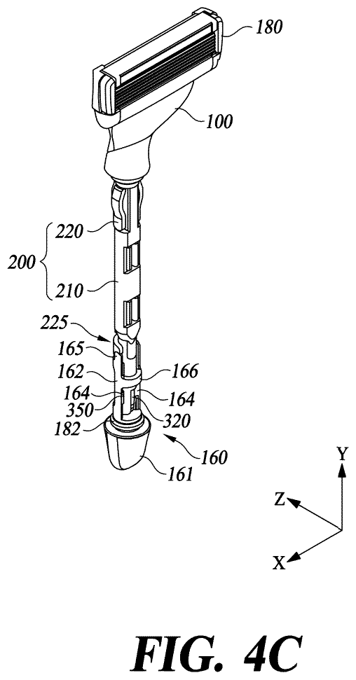

FIG. 4A to FIG. 4C are views showing a process in which the fixing pin 160 according to an embodiment of the present disclosure is moved along at least one guide groove 215. For the convenience of description, the grip portion 140 is not shown in FIG. 4A to FIG. 4C.

Referring to FIG. 4A, the at least one guide groove 215 may comprise a first groove 300, a second groove 320, and a stopper 350. Further, the at least one guide groove 215 may be formed by recessing at least a portion of the body portion 200, for example, the first body portion 210.

The first groove 300 is a part for guiding movement of the guide protrusion 164 that is parallel to the longitudinal direction of the body portion 200. For example, in FIG. 4A, the first groove 300 may extend in a direction parallel to the Y-axis direction and the width of the first groove 300 in the X-axis direction may correspond to the width of the guide protrusion 164 in the X-axis direction, but the present disclosure is not limited thereto.

Further, the first groove 300 may comprise an entry groove 305 that is open at another end of the body portion 200. The entry groove 305, for example, may be configured such that, in FIG. 4A, the width in the X-axis direction at the negative Y-axial end of the first groove 300 is larger than the width in the X-axis direction at the positive Y-axial end. In this case, the entry groove 305 can enable the guide protrusion 164 to more easily enter the first groove 300. The second groove 320 is a part for guiding movement of the guide protrusion 164 in the first direction and the second direction. For example, the second groove 320 may be connected to the first groove 300 and extend in the first direction. In this case, the width of the second groove 320 in the Y-axis direction may correspond to the width of the guide protrusion 164 in the Y-axis direction, but is not necessarily limited thereto.

The stopper 350 is a component stepped at a position adjacent to an end of the second groove 320. For example, the stopper 350 may be formed at a position adjacent to the end of the second groove 320 in the first direction.

Further, the stopper 350 may be formed not only at the end of the second groove 320 in the first direction but also at the end of the second groove 320 in the second direction, and may also be formed at the end of the second groove 320 in the positive Y-axis direction.

Hereafter, the process in which the guide protrusion 164 is moved along at least one guide groove 215 is described in detail.

FIG. 4B shows the state in which the guide protrusion 164 enters the second groove 320 after passing through the first groove 300. In this case, the movement of the guide protrusion 164 in the positive Y-axis direction may be completed. When the stopper 350 is formed at the end of the second groove 320 in the second direction as well, rotation of the fixing pin 160 in the second direction can be stopped by the stopper 350, whereby the rotation direction of the fixing pin 160 can be correctly guided.

Further, when the stopper 350 is formed at the end of the second groove 320 in the positive Y-axis direction, movement of the fixing pin 160 in the positive Y-axis direction can be stopped by the stopper 350, whereby a user can recognize that insertion of the fixing pin 160 in the positive Y-axis direction has been completed.

FIG. 4C shows the state in which the guide protrusion 164 is positioned adjacent to an end of the second groove 320. In this case, the movement of the guide protrusion 164 in the first direction may be completed. Further, in the state shown in FIG. 4C, the fixing pin 160 may be in a state where latch coupling with the latch part 225 has been completed.

In this case, rotation of the fixing pin 160 in the first direction can be stopped by the stopper 350 formed at the end of the second groove 320 in the first direction, whereby a user can recognize that latch coupling of the fixing pin 160 has been completed.

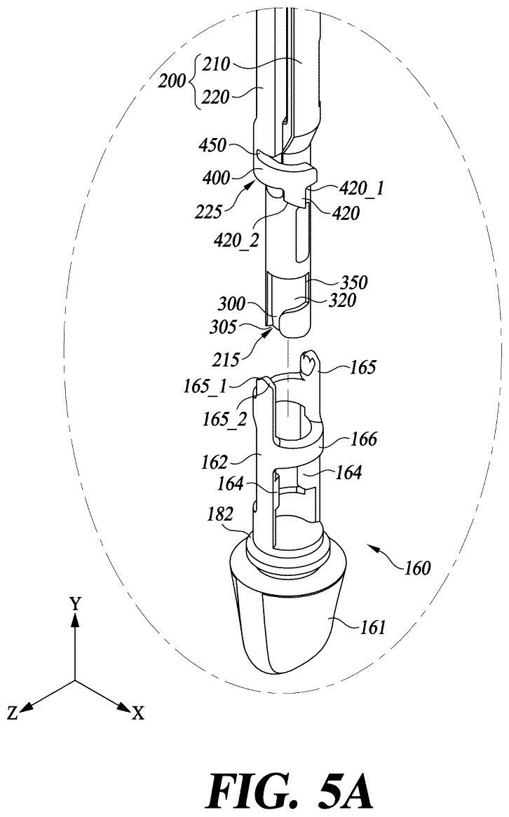

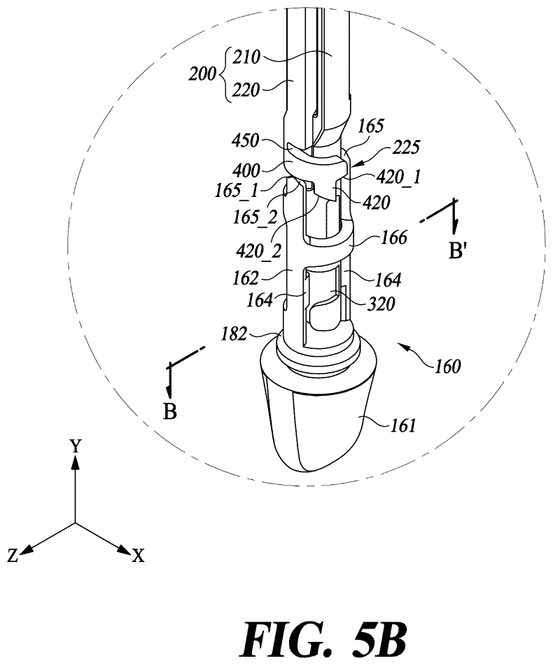

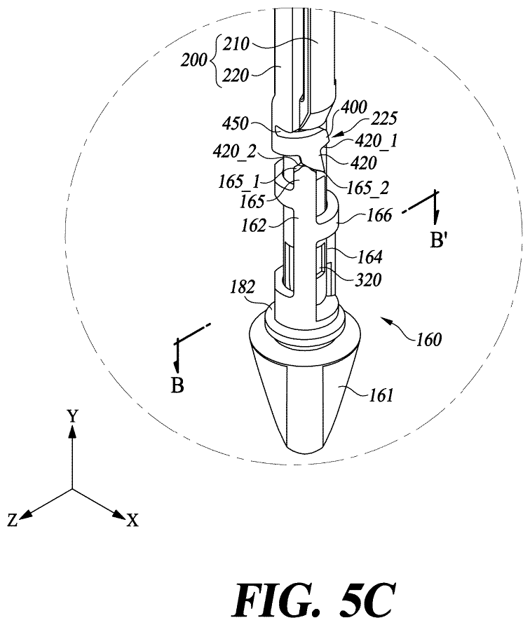

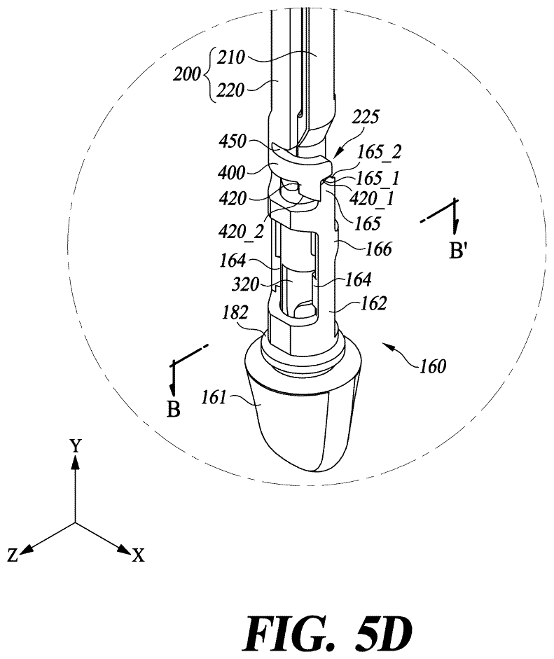

FIG. 5A to FIG. 5D are enlarged views showing a process in which the fixing pin 160 according to an embodiment of the present disclosure is latch-coupled to the latch portion 225. For the convenience of description, the grip portion 140 is not shown in FIG. 5A to FIG. 5D.

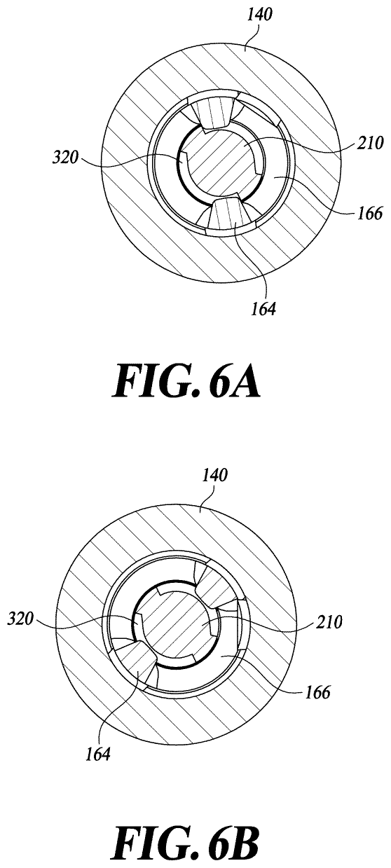

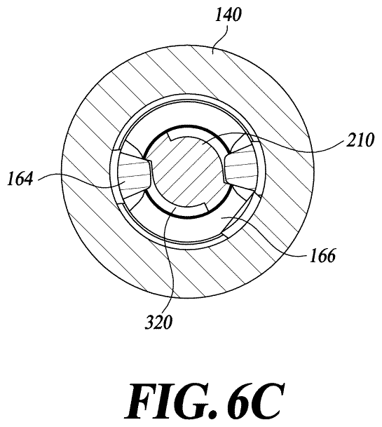

FIG. 6A to FIG. 6C are cross-sectional views shown in the Y-axis direction after cutting the fixing pin 160 and a body portion 200 shown in FIG. 5B to FIG. 5D along line B-B′, including the grip portion 140.

Referring to FIG. 5A, the latch portion 225 may comprise an elastic arm 400 and a locking portion 420.

The elastic arm 400 extends in a direction not parallel to the longitudinal direction of the body portion 200 and a free end of the elastic arm 400 can be moved within a predetermined range. For example, the elastic arm 400 may extend in the first direction, and when the elastic arm 400 is formed at the second body portion 220, it may be configured to surround at least a portion of the first body portion 210. In this case, the free end of the elastic arm 400 can be moved in a direction parallel to the Y-axis direction in FIG. 5A. However, the extension direction and movement direction of the elastic arm 400 are not necessarily limited thereto.

Meanwhile, in order to enable the free end of the elastic arm 400 to move within a predetermined range, the body portion 200 may comprise a gap 450 that is adjacent to a surface of the latch portion 225 that faces the head portion 100.

For example, as shown in FIG. 5A, the gap 450 may be formed at the positive Y-axis side of the latch portion 225 in the positive Y-axis direction, and in this case, the free end of the elastic arm 400 can also be moved in a direction parallel to the Y-axis direction.

The locking portion 420 protrudes at a position adjacent to the free end of the elastic arm 400. For example, the locking portion 420 may protrude in the negative Y-axis direction in FIG. 5A from a region adjacent to the free end of the elastic arm 400. In this case, with respect to the elastic arm 400, the gap 450 may be formed at one side and the locking portion 420 may be formed at the other side. However, the protrusion direction of the locking portion 420 is not necessarily limited thereto.

Meanwhile, the shape of the locking portion 420 may correspond to the shape of the locking portion 165 of the fixing pin 160 for smooth latch coupling.

Hereafter, the process in which the fixing pin 160 is latch-coupled with the latch portion 225 is described in detail.

FIG. 5B and FIG. 6A show the state after a user inserts the fixing pin 160 into the hollow portion 145 of the grip portion 140 shown in FIG. 2. In this case, the locking portion 165 of the fixing pin 160 may be positioned in the second direction with respect to the locking portion 420, and the guide protrusion 164 may have entered the second groove 320. Since the guide protrusion 164 enters the second groove 320, a user can recognize whether the fixing pin 160 has been inserted in the correct direction.

The fixing pin 160 is not yet coupled to the body portion 200 and a user can recognize that the fixing pin 160 has been inserted in the hollow portion 145 by feeling the state in which the locking portion 165 of the fixing pin 160 is in contact with the elastic arm 400 or the guide protrusion 164 is in contact with the end of the second groove 320 in the positive Y-axis direction.

FIG. 5C and FIG. 6B show the state in which a user rotates the fixing pin 160 in the first direction after the locking portion 165 of the fixing pin 160 is brought into contact with the locking portion 420. In this case, the locking portion 165 of the fixing pin 160 may be brought into contact with the end of the locking portion 420 in the negative Y-axis direction, and the guide protrusion 164 may be passing through the central region of the second groove 320.

The fixing pin 160 can apply force to the latch portion 225 in the positive Y-axis direction, and accordingly, the elastic arm 400 including an elastic material can move in the positive Y-axis direction.

Further, in FIG. 5C, although the elastic arm 400 has been moved by the amount of the gap 450 shown in FIG. 5A and FIG. 5B, the movement amount of the elastic arm 400 is not necessarily limited thereto. For example, the elastic arm 400 may be configured to move a distance smaller than the gap 450 shown in FIG. 5A and FIG. 5B, and in this case, the gap 450 may be formed adjacent to a surface of the latch portion 225 with only the size thereof partially reduced.

Meanwhile, for the cam action by the locking portion 165 and the locking portion 420, the locking portion 420 may comprise a first cam surface 420_1 and a second cam surface 420_2, and the locking portion 165 may comprise a third cam surface 165_1 and a fourth cam surface 165_2. The first cam surface 420_1 may be formed on one side of the latch portion 225, for example, at the end of the latch portion 225 in the first direction and the second cam surface 420_2 may be formed on the other side of the latch portion 225, for example, at the end of the latch portion 225 in the second direction.

The cam surface 165_1 is configured to generate cam action with the first cam surface 420_1 and may be formed on the other side of the locking portion 165, for example, at the end of the locking portion 165 in the second direction, and the fourth cam surface 165_2 is configured to generate cam action with the second cam surface 420_2 and may be formed on one side of the locking portion 165, for example, at the end of the locking portion 165 in the first direction.

When the fixing pin 160 is rotated in the first direction after the guide protrusion 164 of the fixing pin 160 enters the second groove 320 by moving along the first groove 300, cam action can be generated by the second cam surface 420_2 and the fourth cam surface 165_2, and latch coupling of the fixing pin 160 and the latch portion 225 can be completed.

Meanwhile, the first cam surface 420_1 may be formed in a continuous curved-surface shape, and in this case, the cam action with the third cam surface 165_1 can be smoothly generated, so latch coupling can be easily completed and disengaged.

Further, the second cam surface 420_2 may comprise a cam surface extending in a direction parallel to the Y-axis direction, and in this case, a predetermined resistance force is generated during latching coupling, which enables a user to recognize whether latch coupling is before or after completion.

Referring to FIG. 5D and FIG. 6C, which show the state in which the fixing pin 160 has been latch-coupled with the latch portion 225, the first cam surface 420_1 and the third cam surface 165_1 may be in contact with each other after cam action is generated.

Further, rotation of the fixing pin 160 in the second direction with the fixing pin 160 latch-coupled to the latch portion 225 can be stopped by the locking portion 420. For example, the locking portion 165 of the fixing pin 160, opposite to FIG. 5B, may be positioned in the first direction with respect to the locking portion 420, and in this case, a user has to intentionally apply force in the second direction to decouple the fixing pin 160, so the fixing pin 160 cannot be easily decoupled.

Meanwhile, though not shown in FIG. 5A to FIG. 5D, the process of decoupling the fixing pin 160 may be performed in the reverse order of the coupling process. In this case, as described above, a user may need to intentionally apply force in the second direction.

When the fixing pin 160 is rotated in the second direction, the latch coupling may be disengaged by the cam action by the first cam surface 420_1 of the locking portion 420 and the third cam surface 165_1 of the locking portion 165. When decoupling is completed, the locking portion 165 of the fixing pin 160 can be positioned in the second direction with respect to the locking portion 420. When the fixing pin 160 is rotated in the second direction, the latch coupling may be disengaged by the cam action by the first cam surface 420_1 of the locking portion 420 and the third cam surface 165_1 of the locking portion 165. When decoupling is completed, the locking portion 165 of the fixing pin 160 can be positioned in the second direction with respect to the locking portion 420.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A razor handle comprising:
an elongated-type grip portion comprising a hollow portion;
a body portion comprising a latch portion, wherein at least part of the body portion configured to be accommodated in the hollow portion;
a head portion configured to be connected to a razor cartridge, the head portion connected to a first side of the body portion; and
a fixing pin configured to be coupled to a second side of the body portion opposing the first side,
wherein when the fixing pin is positioned on the second side of the body portion, the fixing pin is configured to be latch-coupled with the latch portion by rotating in a first direction around a rotational axis passing through the body portion and parallel to a longitudinal direction of the body portion.

2. The razor handle of claim 1, wherein latch coupling of the fixing pin with the latch portion is configured to be disengaged by rotating the fixing pin in a second direction opposite to the first direction.

3. The razor handle of claim 1, wherein when the fixing pin is latch-coupled to the latch portion, at least a portion of the fixing pin is configured to be supported by an end of the grip portion that is adjacent to the fixing pin.

4. The razor handle of claim 1, wherein the body portion comprises at least one guide groove configured to guide latch coupling of the fixing pin.

5. The razor handle of claim 4, wherein the fixing pin comprises:
at least one guide arm extending in a direction parallel to the longitudinal direction of the body portion; and
a guide protrusion protruding from the at least one guide arm and movable along the at least one guide groove.

6. The razor handle of claim 5, wherein the at least one guide arm comprises a locking portion at an end that is latch-coupled to the latch portion and configured to generate cam action with the latch portion.

7. The razor handle of claim 5, wherein the at least one guide arm is provided as a plurality of guide arms spaced apart from each other by a distance corresponding to a diameter of the hollow portion.

8. The razor handle of claim 7, wherein the fixing pin comprises at least one bridge connecting between the plurality of guide arms.

9. The razor handle of claim 5, wherein the at least one guide groove comprises:
a first groove configured to guide movement of the guide protrusion parallel to the longitudinal direction of the body portion; and
a second groove configured to guide movement of the guide protrusion in the first direction and a second direction opposite to the first direction.

10. The razor handle of claim 9, wherein the first groove comprises an entry groove that is open at the other side end of the body portion.

11. The razor handle of claim 9, wherein the at least one guide groove comprises a stopper stepped at a position adjacent to an end of the second groove.

12. The razor handle of claim 11, wherein when the fixing pin is latch-coupled to the latch portion, rotation of the fixing pin in the first direction is configured to be stopped by the stopper.

13. The razor handle of claim 1, wherein the latch portion comprises:
an elastic arm having a free end movable within a predetermined range, as an elastic arm extending in a direction not parallel to the longitudinal direction of the body portion; and
a locking portion protruding adjacent to the free end of the elastic arm.

14. The razor handle of claim 13, wherein the locking portion comprises a first cam surface on a first side and a second cam surface on a second opposing side, and
wherein the fixing pin comprises a third cam surface on the other side thereof configured to generate cam action with the first cam surface and a fourth cam surface on one side thereof configured to generate cam action with the second cam surface.

15. The razor handle of claim 13, wherein when the fixing pin is latch-coupled to the latch portion, rotation of the fixing pin in a second direction opposite to the first direction is configured to be stopped by the locking portion.

16. The razor handle of claim 1, wherein the latch portion comprises an elastic arm comprising a free end movable within a predetermined range, as an elastic arm extending in a direction not parallel to the longitudinal direction of the body portion, and
the body portion comprises a gap adjacent to a surface of the latch portion that faces the head portion.

17. The razor handle of claim 1, wherein the body portion comprises a tension unit configured to elastically support at least a portion of an inner circumferential surface of the hollow portion when at least a portion of the body portion is accommodated in the hollow portion.

18. The razor handle of claim 17, wherein the body portion comprises:
a first body portion including a rigid material; and
a second body portion coupled to at least one side of the first body portion and including an elastic material, and
wherein the latch portion and the tension unit are integrally formed on the second body portion.

19. The razor handle of claim 1, further comprising a buffer unit disposed between an end of the grip portion adjacent to the head portion and the head portion.

20. The razor handle of claim 1, wherein the grip portion includes at least one of materials that are recyclable, reusable, or degradable.
